(19) United States
(12) Patent Application Publication
(10) Pub. No.: US 2016/0346791 A1
(43) Pub. Date: Dec. 1, 2016

(54) FLOTATION CELL AND SYSTEM FOR SEPARATING HYDROPHOBIC PARTICLES FROM A MIXTURE OF PARTICLES AND LIQUID

(71) Applicant: METSO SWEDEN AB, Trelleborg (SE)

(72) Inventor: Mikael Forss, Esbo (FI)

(73) Assignee: Metso Sweden AB, Trelleborg (SE)

(21) Appl. No.: 15/116,551

(22) PCT Filed: Feb. 3, 2015
(86) PCT No.: PCT/EP2015/052111

§ 371 Date: Aug. 4, 2016

(30) Foreign Application Priority Data
Feb. 7, 2014 (SE) 1450132-4

(51) Int. Cl. B03D 1/20; B01F 3/04; B03D 1/24

(52) U.S. Cl. CPC B03D 1/20; B03D 1/242; B01F 3/04539; B01F 2003/04546

(57) ABSTRACT

A flotation cell for separating hydrophobic particles from a mixture of particles and liquid. The cell includes a first inlet through which the mixture is provided into the cell and a second inlet through which a flow of gas is provided into the cell creating bubbles of the gas in the mixture. The cell is characterized in that the second inlet is designed to create a counter pressure for the flow of gas when entering through the second inlet.

### TECHNICAL FIELD

The invention relates to a flotation cell for separating hydrophobic particles from a mixture of particles and liquid.

### BACKGROUND ART

The flotation process is used extensively in industry to separate valuable particles from particles of waste material. In the minerals industry for example, rock containing a valuable component is finely ground and suspended in water. Reagents are generally added that attach selectively to the valuable particles making them hydrophobic, but leaving the unwanted particles in a hydrophilic state. Bubbles of air are introduced into the suspension in a vessel or cell. The hydrophobic particles attach to the bubbles, and rise with them to the surface of the suspension where a froth layer is formed. The froth flows out of the top of the cell carrying the flotation product. The particles that did not attach to bubbles remain in the liquid and are removed as tailings. Frothers may be added, that assist in the creation of a stable froth layer.

Machines and systems for the flotation process are known in prior art. Typically, such a machine consists of an agitator or impeller mounted on a central shaft and immersed in a suitably conditioned pulp in a flotation cell. The rotating impeller creates a turbulent circulating flow within the cell that serves to suspend the particles in the pulp/slurry and prevent them from settling in the vessel, and to disperse a flow of gas that is introduced into the cell into small bubbles, and to cause the bubbles and particles to come into intimate contact, thereby allowing the hydrophobic particles in the pulp to adhere to the bubbles. The bubbles and attached particles float to the surface of the cell where they form a froth layer that flows over a weir, carrying the flotation product.

WO 2008/128044 discloses a flotation separation system for partitioning a slurry that includes a hydrophobic species which can adhere to gas bubbles formed in the slurry. The flotation separation system comprises a flotation separation cell that normally includes a sparger unit and a separation tank. The sparger unit has a slurry inlet for receiving slurry and a gas inlet to receive gas with at least enough pressure to allow bubbles to form in the slurry within the sparger unit. The sparger unit includes a sparging mechanism constructed to disperse gas bubbles within the slurry. The sparging mechanism sparges the gas bubbles to form a bubble dispersion so as to cause adhesion of the hydrophobic species to the gas bubbles substantially within the sparger unit while causing a pressure drop across the sparging mechanism. A problem with the system above and other prior art flotation methods is that it is challenging to achieve a satisfactory extraction efficiency of the flotation process. Any increase in efficiency could potentially lead to highly increased revenues over time.

### SUMMARY OF THE INVENTION

It is an objective of the present invention to provide an improvement of the above technique and prior art. More particularly, it is an objective of this invention to provide a flotation cell with increased efficiency.

These and other objectives, and/or advantages that will be apparent from the following description of embodiments, are achieved, in full or at least in part, by a flotation cell for separating hydrophobic particles from a mixture of particles and liquid. The cell comprises a first inlet through which the mixture is provided into the cell, and a second inlet through which a flow of gas is provided into the cell creating bubbles of the gas in the mixture. The cell is characterised in that the second inlet is designed to create a counter pressure for the flow of gas when entering through the second inlet.

The flow of gas may be supplied from a gas source to the second inlet through a gas passage having a cross sectional area which is larger than a cross sectional area of the second inlet. This configuration is applied in order to provide an increased amount of bubbles with a controlled bubble size. A more even frequency of the bubble size is another advantage. Naturally, the efficiency in separating desirable particles from the mixture will increase with an increased amount of bubbles with a controlled size present in the mixture. In order to achieve or enhance the above the second inlet may also comprise a plurality of openings.

The second inlet may be adjustable in order to control the size of the bubbles. This way, the bubble size can be adapted in view of the type of particles that is to be separated from the mixture in the cell. In one embodiment of the invention the openings of the second inlet is cover by plastic plugs which in turn may be used in order to control the size of the opening by, for example, drilling holes through the plugs, with varying diameter and number of holes.

The flotation cell may further comprise an agitator means having a shaft extending in a substantially vertical direction of the cell, and an impeller which is connected to the lower end of the shaft of the agitator means. The function of the agitator means and the impeller is to provide local mixing of the mixture of particles and liquid fed into the cell, distribute the bubbles in the cell and to prevent channelling of liquid and gas rising in the cell.

The gas passage may be a gas supply pipe, at the end of which said second inlet is arranged, in the lower section of the cell. The gas supply pipe may further be coaxially arranged within said shaft of said agitator means. This is a preferred embodiment of the present invention which is easy to manufacture and which can be applied to existing flotation cells without an extensive modification of the same.

The flotation cell may further comprise a restrictor device having the shape of a cylinder which is closed in its lower end and where a plurality of openings is provided through its outer wall. The cross sectional area of the cylinder shaped restrictor device may be larger than the total cross sectional area of the openings. This is an easy and reliable way to control the bubble size fed into the mixture of the cell. The amount of the bubbles will increase while the size of the same will decrease creating perfect conditions for the particles to attach.

As an alternative embodiment, the restrictor device may have the shape of a cylinder which is closed in its lower end and wherein the plurality of openings is provided through the closed lower end.

Other objectives, features and advantages of the present invention will appear from the following detailed disclosure, from the attached claims, as well as from the drawings. It is noted that the invention relates to all possible combinations of features.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise.

As used herein, the term “comprising” and variations of that term are not intended to exclude other additives, components, integers or steps.

The term “vertical direction” means the vertical direction in relation to the flotation cell when in an upright position.

The term “counter pressure” has the same meaning as back pressure. What is meant by the term is that the gas entering into the tank will be pressurized (by the counter pressure) even further than the pressurization of the gas created by the resistance of the mixture present in the flotation cell.

The term “inlet” could mean any type of opening, a plurality of openings or any type of pipe leading into the flotation cell.

### BRIEF DESCRIPTION OF THE DRAWINGS

The above, as well as additional objects, features and advantages of the present invention, will be better understood through the following illustrative and non-limiting detailed description of embodiments of the present invention, with reference to the appended drawings, where the same reference numerals will be used for similar elements, and wherein:

FIG. 1 is a perspective view of a flotation cell according to one embodiment of the invention,

FIG. 2 is an enlargement of a part of said flotation cell, and

FIG. 3 is an enlargement of a restrictor device of said flotation cell.

### DETAILED DESCRIPTION OF PREFERRED EMBODIMENTS OF THE INVENTION

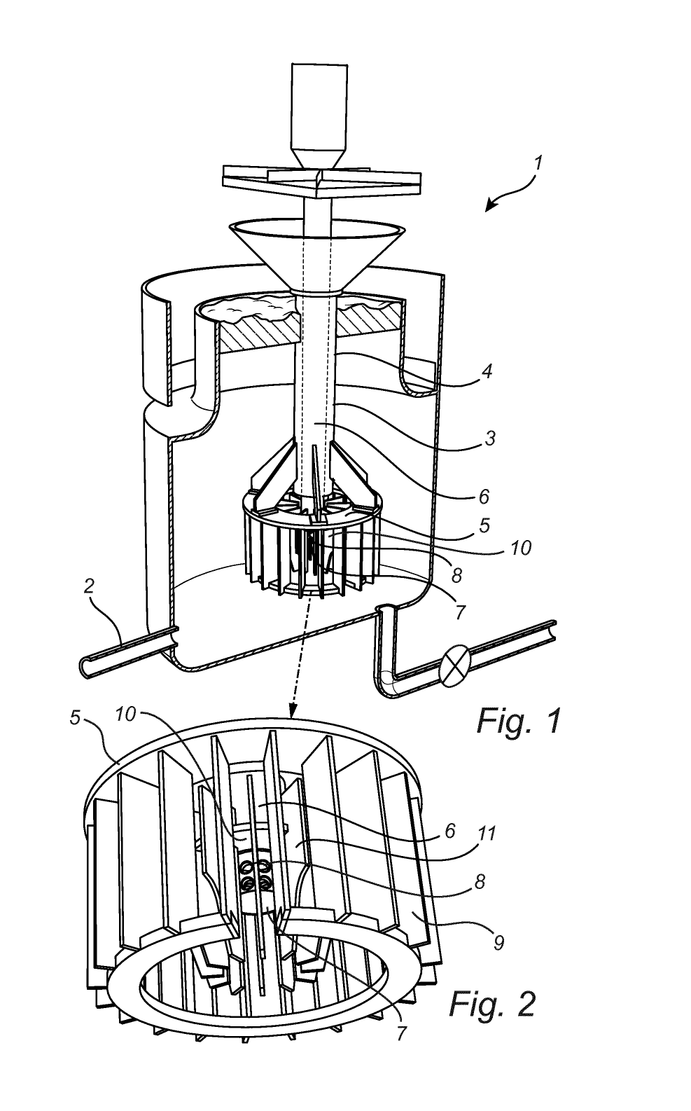

In FIG. 1, a flotation cell 1 for separating hydrophobic particles from a mixture of particles and liquid according to one exemplary embodiment of the invention is illustrated. The flotation cell 1 can be described as a large container into which the mixture of particles and liquid is fed through a first inlet pipe 2 to the bottom section of the flotation cell 1. The flotation cell 1 has an agitator 3 which comprises a shaft 4 extending from the top section of the flotation cell 1, in a vertical direction, and down to the bottom section of the flotation cell 1. The agitator 3 has a diffuser 5 connected to the lower end of the shaft 4 and a impeller 10 which is provided within the diffuser 5. The flotation cell 1 has an air supply pipe 6 which supplies air from the ambient into the flotation cell 1. The air supply pipe 6 is coaxially arranged within the shaft 4 of the agitator 3 and comprises an air dispenser 7 at its lower end.

The air dispenser 7 is cylinder shaped and closed at its bottom end. The air dispenser 7 comprises a plurality of openings 8 which have a combined total cross sectional area which is smaller than the cross sectional area of the air supply pipe 6, in order to create a counter pressure for the air flow entering into the flotation cell 1 through the air supply pipe 6. This way, the pressure of the air entering into the flotation cell 1 will exceed the hydrostatic pressure in the air supply pipe 6 induced by the mixture present in the flotation cell 1. The openings 8 of the air dispenser 7 will also control the size of the air bubbles and create an evenly applied flow of air into the flotation cell 1. In turn, turbulation within the flotation cell 1 will be minimized.

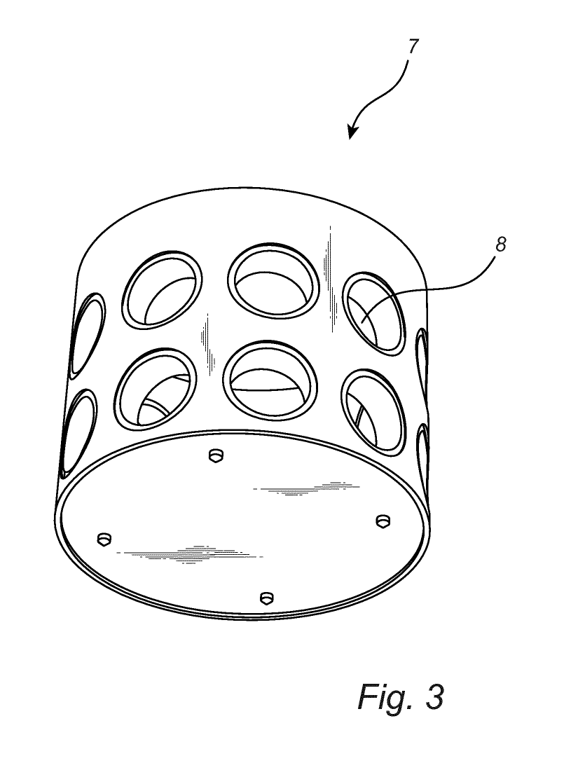

FIG. 2 illustrates a part of the flotation cell 1 including the diffuser 5, the impeller 10 and the air dispenser 7. Both the diffuser 5 and the impeller 10 have a plurality of flanges 9, 11 extending in a radial direction from a geometric axis of the shaft 4 of the agitator 3. The main object of the diffuser 5 and the impeller 10 is to provide local mixing of the mixture of particles and liquid fed into the flotation cell 1 and distribute the air bubbles introduced into the cell 1 through the air dispenser 7.

In FIG. 3, the air dispenser 7 of the flotation cell 1 is illustrated. The air dispenser 7 is provided within the impeller 10 at the lower end of the shaft 4 of the agitator 3.

For purposes of clarification, the flotation cell 1 can be described in terms of four zones (from bottom to top), a mixing zone, a fluidization zone, a disengagement zone, and a froth layer. In the mixing zone, new feed and bubbles are mixed and dispersed uniformly across the cell. The liquid and bubbles pass into the fluidization zone, where the liquid fluidises the bed and keeps the particles in suspension, while the bubbles pass through the bed, collecting hydrophobic particles as they rise. Above the fluidization zone is the disengagement zone that is substantially liquid alone, although it may contain particles that have been entrained and/or entrapped in the wakes of the rising bubbles that disengage from the wakes and fall back into the fluidized bed. At top of the cell 1 is the froth zone, formed by the bubbles carrying their load of attached particles. The froth discharges from the cell 1 as the flotation product.

In operation of the flotation cell 1, feed slurry is introduced near the bottom of the cell 1, and is distributed uniformly by the stirring action of the impeller 10. The design and operating speed of the impeller 10 are such that a well-mixed zone is created in the bottom of the fluidized bed, but this zone is restricted to the lower regions of the bed. The fluidizing water can be included in the feed entering the cell 1 near the impeller 10, or it could come from the recycling of liquid taken from above the fluidized bed in the cell 1. Air is introduced through the air supply pipe 6 and dispersed into small bubbles by the air dispenser 7 attached at the end of the agitator 3 and by the action of the impeller. The well-mixed feed and dispersed bubbles rise into a fluidization zone, where the bubbles attach to hydrophobic particles and carry them upwards into a disengagement zone, and then into a froth zone at the top of the flotation cell 1. Tailings may be removed from the cell through a pipe or port at the bottom of the fluidization zone.

The mixing and pumping characteristics in the flotation cell 1 must be such that any turbulence developed by the impeller 10 is restricted to the region at the base of the fluidized bed. To this end, the impeller 10 may be surrounded by baffles or flanges that allow a high degree of mixing, but prevent swirling and development of large-scale circulatory motions. The turbulence generated by the impeller 10 is dampened by the high concentration of particles in the fluidized bed, so that in the upper regions of the bed the bubbles are rising through a quiescent environment that is conducive to the maintenance of the attachment between bubbles and hydrophobic particles.

The bubbles rise through the fluidized bed of particles. The probability of collision between a hydrophobic particle and an air bubble is very high, because the rising bubbles must push the particles away from their path as they rise. Thus the probability of particle capture is also high.

According to a second aspect of the invention a flotation cell for separating hydrophobic particles from a mixture of particles and liquid is provided. The flotation cell comprises a first inlet through which the mixture is provided into the cell, a second inlet through which a flow of gas is provided into the cell creating bubbles of the gas in the mixture. The flotation cell is characterised in that said cell further comprises a gas dispenser provided in connection with the second inlet, the gas dispenser being adapted to control the size of the bubbles of gas.

The skilled person realizes that a number of modifications of the embodiments described herein are possible without departing from the scope of the invention, which is defined in the appended claims.

For instance, the size and shape of the flotation cell as well as the parts included in the same may be varied.

1. Flotation cell for separating hydrophobic particles from a mixture of particles and liquid, said flotation cell comprising:
a first inlet through which the mixture is provided into the cell, and a second inlet through which a flow of gas is provided into the cell creating bubbles of said gas in the mixture, wherein said second inlet is designed to create a counter pressure for said flow of gas when entering through said second inlet.

2. Flotation cell according to claim 1, wherein said flow of gas is supplied to said second inlet through a gas passage having a cross sectional area which is larger than a cross sectional area of said second inlet.

3. Flotation cell according to claim 1, wherein said second inlet comprises a plurality of openings.

4. Flotation cell according to claim 2, wherein the cross sectional area of said second inlet is adjustable in order to control the size of said bubbles.

5. Flotation cell according to claim 1, wherein said first inlet is provided in the lower part of the cell.

6. Flotation cell according to claim 1, further comprising an agitator having a shaft extending in a substantially vertical direction of said cell.

7. Flotation cell according to claim 6, further comprising an impeller connected to the lower end of said shaft of said agitator.

8. Flotation cell according to claim 2, wherein said gas passage is a gas supply pipe, at the end of which said second inlet (8) is arranged, in the lower section of the cell.

9. Flotation cell according to claim 8, wherein said is a gas supply pipe is coaxially arranged within said shaft of said agitator.

10. Flotation cell according to claim 1, wherein said second inlet comprises a restrictor device, said restrictor device being adapted to restrict the cross sectional area of said second inlet.

11. Flotation cell according to claim 10 wherein said second inlet opening comprises a plurality of openings, wherein said restrictor device has the shape of a cylinder which is closed in its lower end and said plurality of openings is provided through an outer wall.

12. Flotation cell according to claim 10 wherein said second inlet opening comprises a plurality of openings, wherein said restrictor device has the shape of a cylinder which is closed in its lower end and said plurality of openings is provided through said closed lower end.

13. Flotation cell according to claim 11, wherein the cross sectional area of the cylinder shaped restrictor device is larger than the overall cross sectional area of said openings.

14. Flotation cell according to claim 1, wherein said gas is air.

15. A system for separating hydrophobic particles from a mixture of particles and liquid, said system comprising at least two flotation cells according to claim 1, interconnected in series.

16. Flotation cell according to claim 12, wherein the cross sectional area of the cylinder shaped restrictor device is larger than the overall cross sectional area of said openings.
